(19) United States
(12) Patent Application Publication
(10) Pub. No.: US 2024/0313882 A1
(43) Pub. Date: Sep. 19, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Chuanfeng HE, Dongguan (CN)

(21) Appl. No.: 18/676,404

(22) Filed: May 28, 2024

Related U.S. Application Data
(63) Continuation of application No. PCT/CN2022/071119, filed on Jan. 10, 2022.

(51) Int. Cl. H04L 1/00; H04L 1/08; H04W 74/00

(52) U.S. Cl. CPC H04L 1/0003; H04L 1/08; H04W 74/004

(57) ABSTRACT

Provided is a method for wireless communication. The method includes: determining, by a terminal device, a target modulation and coding scheme (MCS) for transmitting a physical uplink shared channel (PUSCH) based on a target MCS parameter and a target MCS information field, wherein the target MCS parameter indicates N MCS indexes, N being a positive integer greater than 1, and the PUSCH is configured to carry a message 3 (Msg3) in a random access process.

### CROSS-REFERENCE TO RELATED APPLICATION

This application is a continuation of International Application No. PCT/CN2022/071119, filed Jan. 10, 2022, the entire disclosure of which is incorporated herein by reference.

### TECHNICAL FIELD

Embodiments of the present disclosure relate to the field of communications, and in particular, relate to a method for wireless communication, a terminal device, and a network device.

### BACKGROUND

In a new radio (NR) system, for supporting ultra-reliable and low-latency communications (URLLC) services, transmission reliability is improved by employing repetition for transmission of uplink data.

In the NR system, a four-step random access process is supported, which includes a transmission process of a message 1 (Msg1) to a message 4 (Msg4). A message 3 (Msg3) is carried over a physical uplink shared channel (PUSCH).

### SUMMARY

The present disclosure provides a method for wireless communication, a terminal device, and a network device.

According to some embodiments of the present disclosure, a method for wireless communication is provided. The method includes: determining, by a terminal device, a target modulation and coding scheme (MCS) for transmitting a physical uplink shared channel (PUSCH) based on a target MCS parameter and a target MCS information field, wherein the target MCS parameter indicates N MCS indexes, N being a positive integer greater than 1, and the PUSCH is configured to carry a message 3 (Msg3) in a random access process.

According to some embodiments of the present disclosure, a method for wireless communication is provided. The method includes: transmitting, by a network device, a target modulation and coding scheme (MCS) parameter to a terminal device, wherein the target MCS parameter is configured to determine a target MCS for transmitting a physical uplink shared channel (PUSCH), the target MCS parameter indicates N MCS indexes, N being a positive integer greater than 1, and the PUSCH is configured to carry a message 3 (Msg3) during a random access process.

According to some embodiments of the present disclosure, a terminal device is provided. The terminal device is configured to perform the method as defined in the first aspect or any embodiment thereof.

In some embodiments, the terminal device includes a functional module configured to perform the method as defined in the first aspect or any embodiment thereof.

According to some embodiments of the present disclosure, a network device is provided. The network device is configured to perform the method as defined in the second aspect or any embodiment thereof.

In some embodiments, the network device includes a functional module configured to perform the method as defined in the second aspect or any embodiment thereof.

According to some embodiments of the present disclosure, a terminal device is provided. The terminal device includes a processor and a memory. The memory is configured to store a computer program, and the processor, when loading and running the computer program stored in the memory, is caused to perform the method as defined in the first aspect or any embodiment thereof.

According to some embodiments of the present disclosure, a network device is provided. The network device includes a processor and a memory. The memory is configured to store a computer program, and the processor, when loading and running the computer program stored in the memory, is caused to perform the method as defined in the second aspect or any embodiment thereof.

According to some embodiments of the present disclosure, a chip is provided. The chip is configured to perform the method as defined in any one of the first aspect to the second aspect or any embodiment thereof.

In some embodiments, the chip includes: a processor, wherein the processor, when loading and running a computer program from a memory, causes a device installed with the chip to perform the method as defined in any one of the first aspect to the second aspect or any embodiment thereof.

According to some embodiments of the present disclosure, a non-transitory computer-readable storage medium for storing a computer program is provided. The computer program, when loaded and run on a computer, causes the computer to perform the method as defined in any one of the first aspect to the second aspect or any embodiment thereof.

According to some embodiments of the present disclosure, a computer program product is provided. The computer program product includes a computer program instruction, wherein the computer program instruction, when loaded and run on a computer, causes the computer to perform the method as defined in any one of the first aspect to the second aspect or any embodiment thereof.

According to some embodiments of the present disclosure, a computer program is provided. The computer program, when loaded and run on a computer, causes the computer to perform the method as defined in any one of the first aspect to the second aspect or any embodiment thereof.

### BRIEF DESCRIPTION OF THE DRAWINGS

FIG. 1 is a schematic diagram of a communication system architecture according to some embodiments of the present disclosure.

FIG. 2 is a schematic diagram of a four-step random access process.

FIG. 3 is a schematic interaction diagram of a method for wireless communication according to some embodiments of the present disclosure.

FIG. 4 is a schematic block diagram of a terminal device according to some embodiments of the present disclosure.

FIG. 5 is a schematic block diagram of a network device according to some embodiments of the present disclosure.

FIG. 6 is a schematic block diagram of a communication device according to some embodiments of the present disclosure.

FIG. 7 is a schematic block diagram of a chip according to some embodiments of the present disclosure.

FIG. 8 is a schematic block diagram of a communication system according to some embodiments of the present disclosure.

### DETAILED DESCRIPTION

Technical solutions in the embodiments of the present disclosure will be described hereinafter with reference to the accompanying drawings in the embodiments of the present disclosure, and it is apparent that the described embodiments are only a part, but not all of the embodiments of the present disclosure. All other embodiments acquired by those of ordinary skills in the art without creative efforts with respect to the embodiments in the present disclosure shall fall within protection scope of the present disclosure.

The technical solutions of the embodiments of the present disclosure are applicable to various communication systems, such as a global system of mobile communication (GSM) system, a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), wireless local area networks (WLANs), wireless fidelity (Wi-Fi), a 5th-generation (5G) system, or other communication systems.

Generally, conventional communication systems support a limited number of connections and are easy to implement. However, with development of communication technologies, mobile communication systems will support not only conventional communications, but also other communications, such as device-to-device (D2D) communications, machine-to-machine (M2M) communications, machine type communications (MTCs), vehicle-to-vehicle (V2V) communications, or vehicle-to-everything (V2X) communications, and the embodiments of the present disclosure are also applicable to these communication systems.

In some embodiments, the communication systems in the embodiments of the present disclosure are applicable to a carrier aggregation (CA) scenario, a dual connectivity (DC) scenario, or a standalone (SA) networking scenario.

In some embodiments, the communication systems in the embodiments of the present disclosure are applicable to an unlicensed spectrum, wherein the unlicensed spectrum is considered as a shared spectrum; or the communication systems in the embodiments of the present disclosure are applicable to a licensed spectrum, wherein the licensed spectrum is considered as an unshared spectrum.

The embodiments of the present disclosure are described in conjunction with a network device and a terminal device, wherein the terminal device may also be referred to as a user equipment (UE), an access terminal, a subscriber unit, a subscriber station, a rover station, a mobile station, a remote station, a remote terminal, a mobile device, a user terminal, a terminal, a wireless communication device, a user agent, or a user device.

The terminal device may be a station (ST) in WLAN, or a cellular phone, a cordless phone, a Session Initiation Protocol (SIP) phone, a wireless local loop (WLL) station, a personal digital assistant (PDA) device, a handheld device with a wireless communication function, a computing device, or another processing device connected to a wireless modem, a vehicle-mounted device, a wearable device, a terminal device in a next generation communication system, such as an NR network, or a terminal device in an evolved public land mobile network (PLMN), or the like.

In the embodiments of the present disclosure, the terminal device may be deployed on land, including indoor or outdoor, handheld, wearable or vehicle-mounted; or deployed on the water surface (such as a ship); or deployed in the air (such as an airplane, a balloon, or a satellite).

In the embodiments of the present disclosure, the terminal device may be a mobile phone, a tablet computer (pad), a computer with a wireless transceiving function, a virtual reality (VR) terminal device, an augmented reality (AR) terminal device, a wireless terminal device in industrial control, a wireless terminal device in self-driving, a wireless terminal device in a remote medical system, a wireless terminal device in smart grid, a wireless terminal device in transportation safety, a wireless terminal device in smart city, or a wireless terminal device in smart home.

By way of example and not limitation, in the embodiments of the present disclosure, the terminal device may be a wearable device. The wearable device, also known as a wearable smart device, is a generic name of wearable devices, such as glasses, gloves, watches, clothing, and shoes, which are intelligently designed and developed for daily wear by using wearable technologies. The wearable device is a portable device that is worn directly on the body or integrated into the user's clothing or accessories. The wearable device is not only a hardware device, but also implementing powerful functions based on software support, data interaction, and cloud interaction. Generally, wearable smart devices include devices, such as smart watches or smart glasses, that have full functions and large size, and implement complete or partial functions without depending on smart phones, and devices, such as various kinds of smart bracelets and smart jewelry for physical sign monitoring, that only focus on a certain type of application function, and need to be matched with other devices such as smart phones for use.

In the embodiments of the present disclosure, the network device may be a device for communication with a mobile device, and the network device may be an access point (AP) in WLAN, a base transceiver station (BTS) in GSM or CDMA, a NodeB (NB) in WCDMA, an evolutional Node B (eNB, or eNodeB) in LTE, a relay station or an access point, a vehicle-mounted device, a wearable device, a network device (gNB) in an NR network, a network device in an evolved PLMN network, or a network device in an NTN network.

By way of example and not limitation, in the embodiments of the present disclosure, the network device may have a mobile nature. For example, the network device is a mobile device. In some embodiments, the network device is a satellite, or a balloon station. For example, the satellite is a low earth orbit (LEO) satellite, a medium earth orbit (MEO) satellite, a geostationary earth orbit (GEO) satellite, a high elliptical orbit (HEO) satellite, or the like. In some embodiments, the network device is a base station located on land, in water, or the like.

In the embodiments of the present disclosure, the network device may provide a service for a cell, and a terminal device communicates with the network device based on a transmission resource (e.g., a frequency domain resource or a frequency spectrum resource) utilized by the cell, wherein the cell is a cell corresponding to the network device (e.g., a base station), and the cell may belong to a macro base station or to a base station corresponding to a small cell. For example, the small cell includes: a metro cell, a micro cell, a pico cell, a femto cell, or the like. The small cells have the characteristics of small coverage area and low transmission power, and are suitable for providing high-rate data transmission services.

In some embodiments, a communication system 100 applied in the embodiments of the present disclosure is illustrated in FIG. 1. The communication system 100 includes a network device 110, wherein the network device 110 is a device communicating with a terminal device 120 (or referred to as a communication terminal, or a terminal). The network device 110 provides communication coverage for a particular geographic region and communicates with terminal devices located within a coverage region.

FIG. 1 exemplarily shows one network device and two terminal devices. In some embodiments, the communication system 100 includes a plurality of network devices and a coverage region of each of the network devices includes other number of terminal devices, which are not limited in the embodiments of the present disclosure.

In some embodiments, the communication system 100 further includes other network entities, such as a network controller and a mobile management entity, which is not limited in the embodiments of the present disclosure.

It is understandable that a device having a communication function in the network/system in the embodiments of the present disclosure may be referred to as a communication device. In the communication system 100 shown in FIG. 1, for example, the communication device includes a network device 110 and a terminal device 120 having a communication function, and the network device 110 and the terminal device 120 are devices that have been specifically described above, which are not repeated herein. In some embodiments, the communication device further includes other devices in the communication system 100, such as other network entities, for example, a network controller and a mobile management entity, which is not limited in the embodiments of the present disclosure.

It is understandable that terms “system” and “network” herein are often used interchangeably; and the term “and/or” herein is merely an association relationship describing associated objects, and refers to that there can be three relationships. For example, A and/or B may mean that: A is present alone, A and B are present simultaneously, and B is present alone. In addition, the symbol “/” herein generally indicates an “or” relationship between the associated objects.

It is understandable that the “indication” mentioned in the embodiments of the present disclosure may be a direct indication, an indirect indication, or an indication that there is an association relationship. For example, A indicates B, which may mean that A indicates B directly, e.g., B is acquired by A; or that A indicates B indirectly, e.g., A indicates C, wherein B is acquired by C; or that an association relationship is present between A and B.

In the description of the embodiments of the present disclosure, the term “corresponding” may indicate a direct corresponding relationship or an indirect corresponding relationship between two items, or indicate an association relationship between two items. It may also indicate relationships such as indicating and being indicated, configuring and being configured, or the like.

In the embodiments of the present disclosure, “predefined” may be implemented by pre-storing a corresponding code, a table, or another manner that may be configured to indicate related information in a device (for example, a terminal device or a network device), and the present disclosure does not limit the specific implementation thereof. For example, “predefined” refers to “defined” in a protocol.

In the embodiments of the present disclosure, the “protocol” may refer to a standard protocol in the communication field. For example, the protocol includes an LTE protocol, an NR protocol, or a related protocol applied in future communication systems, which is not limited in the present disclosure.

For facilitating understanding of the technical solutions of the embodiments of the present disclosure, the technical solutions of the present disclosure are described in detail hereinafter with specific embodiments. As an alternative, the following related technologies may be combined with the technical solutions of the embodiments of the present disclosure in any manner, all of which fall within the protection scope of the embodiments of the present disclosure. The embodiments of the present disclosure include at least some of the following content.

In an NR system, a network device transmits an uplink grant (UL grant), wherein the UL grant is carried in downlink control information (DCI), the DCI being DCI format 0_0 or DCI format 0_1 to schedule a physical uplink shared channel (PUSCH) for transmission.

In the case that the network device schedules uplink data transmission by the DCI carrying the UL grant, the DCI carries a time domain resource allocation (TDRA) field. The TDRA field is four bits and may indicate 16 different rows in a time domain resource allocation table, wherein each of the rows includes a distinct resource allocation combination, such as a starting position S, a length L and a k2 of the PUSCH, and a distinct mapping type. The k2 represents a number of slots shifted between a slot where the DCI is located and a slot where the PUSCH is located. Types of time domain resource allocation of the PUSCH include Type A and Type B. Type A and Type B are different in value ranges of corresponding S candidate values and L candidate values. Type A is mainly oriented to slot-based services, such that S is advanced, and L is long. Type B is mainly oriented to ultra-reliable and low-latency communication (URLLC) services, and has a high requirement on latency, such that the position of S is flexible to facilitate transmission of the URLLC services that may arrive at any time, and L is short, which can reduce the transmission latency. The selectable value ranges of S and L are shown in Table 1 below.

TABLE 1

| PUSCH | Normal cyclic prefix | | | Extended cyclic prefix | | |
|---|---|---|---|---|---|---|
| type | S | L | S + L | S | L | S + L |
| Type A | 0 | {4, . . . , 14} | {4, . . . , 14} | 0 | {4, . . . , 12} | {4, . . . , 12} |
| | | | (only for repetition of Type A) | | | |
| Type B | {0, . . . , 13} | {1, . . . , 14} | {1, . . . , 14} | {0, . . . , 11} | {1, . . . , 12} | {1, . . . , 12} |
| | | | (for repetition of Type A), | | | |
| | | | {1, . . . , 27} | | | |
| | | | (for repetition of Type B) | | | |

The DCI carrying the UL grant includes frequency domain resource information, MCS, transmission power control (TPC), frequency hopping information, a redundancy version, a hybrid automatic repeat request (HARQ) process identifier, or the like, in addition to the above time domain resource allocation information, which is not repeated herein.

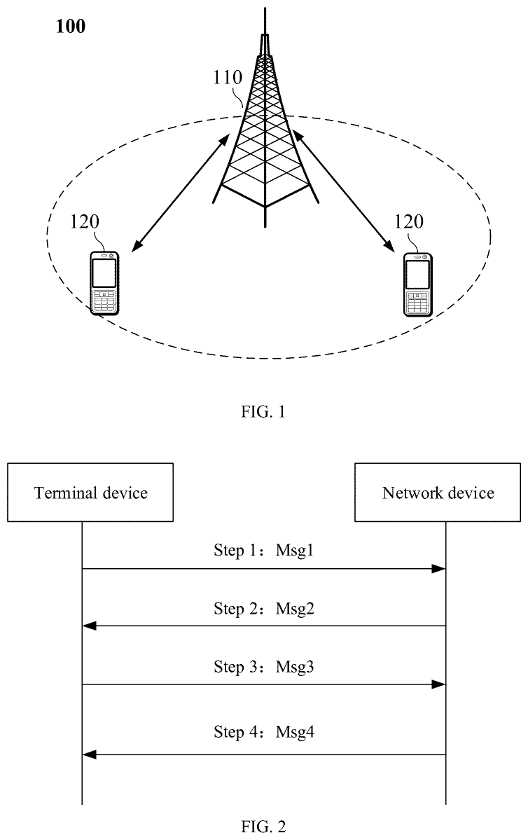

In the NR system, a four-step random access process is supported, which includes a transmission process of a message 1 (Msg1) to a message 4 (Msg4). For example, as shown in FIG. 2, the four-step random access process includes the following steps.

In step 1, a terminal device transmits a random access preamble (i.e., the Msg1) to a network device.

The random access preamble may also be referred to as a preamble, a random access preamble sequence, a preamble sequence, or the like.

In some embodiments, the terminal device selects a physical random access channel (PRACH) resource, which may include a time domain resource, a frequency domain resource, and a code domain resource. The network device transmits a random access related parameter to the terminal device by a broadcast system information block (SIB) 1, wherein a reference signal receiving power (RSRP) threshold value for a synchronization signal block (SSB) (rsrp-ThresholdSSB) in an RACH-common configuration information element (RACH-ConfigCommon IE) is configured for SSB selection by the terminal device. The terminal device compares an RSRP measurement result of each SSB with the rsrp-ThresholdSSB and selects an SSB with a measurement value greater than the configured threshold value for access, and randomly selects one SSB from all SSBs for access in the case that no SSB satisfies the configured threshold value. Each SSB corresponds to a set of random access preamble resources and RACH occasion (RO) resources. The terminal device randomly selects from contention-based random access resources in the selected SSB, and sets a preamble index (PREAMBLE_INDEX) as the selected random access preamble. The network device can estimate the transmission latency between the network device and the terminal device based on the preamble, calibrate uplink timing based on the transmission latency, and generally determine the size of the resource required by the terminal device to transmit Msg3. For allowing the network device to allocate appropriate uplink resources by knowing the size of to-be-transmitted Msg3 more accurately, the preambles are divided into a preamble group A and a preamble group B. In the case that the preamble group B exists in the random access resources, the terminal device can select the preamble group based on the size of the Msg3 and a pathloss.

In step 2, the network device transmits a random access response (RAR, i.e., Msg2) to the terminal device.

In some embodiments, upon transmitting the preamble to the network device, the terminal device opens a random access response window (ra-ResponseWindow), and detect a corresponding physical downlink control channel (PDCCH) in the ra-ResponseWindow based on a random access radio network temporary identifier (RA-RNTI). In the case that the terminal device detects the PDCCH scrambled by the RA-RNTI, the terminal device acquires a physical downlink shared channel (PDSCH) scheduled by the PDCCH. The PDSCH includes the RAR corresponding to the preamble.

The RA-RNTI is calculated based on a time-frequency position of the PRACH that transmits the preamble. Therefore, in the case that a plurality of terminal devices transmit the preamble on the same RO, the corresponding RAR is multiplexed in the same RAR media access control protocol data unit (MAC PDU). In the case that the terminal successfully receives the PDCCH scrambled by the RA-RNTI corresponding to the RO resource transmitting the preamble and the RAR includes a random access preamble identifier (RAPID) carried by a MAC subPDU that corresponds to the PREAMBLE_INDEX selected from the above Msg1, the RAR is successfully received. The terminal proceeds with the Msg3 by performing decoding to acquire a timing advance command (TAC), an uplink grant resource (UL grant), and a temporary cell radio network temporary identity (TC-RNTI).

In the case that the PDCCH scrambled by the RA-RNTI corresponding to the RO resource transmitting the preamble is not received during the operation of the ra-Response Window, or the PDCCH scrambled by the RA-RNTI is received during the operation of the ra-Response Window but the RAR does not include the MAC subPDU corresponding to the PREAMBLE_INDEX, the reception of the RAR is considered to fail. In this case, the terminal device needs to retransmit the Msg1 in the case that the transmission number of the preamble does not exceed a maximum transmission number (preambleTransMax) configured by the network, and the terminal device reports a random access problem to an upper layer in the case that the transmission number of the preamble exceeds the maximum transmission number (preambleTransMax) configured by the network.

In step 3, the terminal device transmits the Msg3.

Upon receiving the RAR message, the terminal device determines whether the RAR message belongs to the terminal device itself. For example, the terminal device checks by using a preamble index. In the case that the terminal device determines that the RAR message belongs to the terminal device itself, the terminal device generates the Msg3 at an RRC layer and transmits the Msg3 to the network device, wherein the Msg3 carries identification information of the terminal device.

The Msg3 is mainly configured to inform the network device of a trigger event of the random access. The Msg3 transmitted by the terminal device in step 3 may include different content for different random access trigger events.

For example, in an initial access scenario, the Msg3 includes an RRC setup request message generated at the RRC layer. In some embodiments, the Msg3 further carries a 5G serving-temporary mobile subscriber identity (S-TMSI) of the terminal device or a nonce.

For another example, in an RRC reestablishment scenario, the Msg3 includes an RRC reestablishment request message generated at the RRC layer. In some embodiments, the Msg3 further carries a cell radio network temporary identifier (C-RNTI), and the like.

For another example, in a handover scenario, the Msg3 includes an RRC handover confirm message generated at the RRC layer, wherein the RRC handover confirm message carries the C-RNTI of the terminal device. In some embodiments, the Msg3 further carries a buffer status report (BSR) and other information. For other trigger events, such as a scenario of uplink/downlink data arrival, the Msg3 may include at least the C-RNTI of the terminal device.

In step 4, the network device transmits a contention resolution message (i.e., Msg4) to the terminal device.

The network device transmits the Msg4 to the terminal device, and the terminal device completes contention resolution by correctly receiving the Msg4. For example, in the RRC establishment process, the Msg4 carries an RRC establishment message.

The message 3 (Msg3) is carried by a physical uplink shared channel (PUSCH). The RAR in the Msg2 carries a UL grant of the PUSCH for the initial transmission of the Msg3, wherein the UL grant carried in the RAR is referred to as an RAR UL grant. The information carried by the RAR UL grant information may include time domain and frequency domain resource allocation information of the PUSCH, transmission power control (TPC), frequency hopping, MCS, and the like.

In the case that the network device does not correctly receive the Msg3, the scheduling information for retransmission of the Msg3 may be indicated by the DCI, for example, the scheduling information is carried by the DCI format 0_0 scrambled by a temporary cell radio network temporary identifier (TC-RNTI). The DCI includes a new data indicator (NDI), a redundancy version, and an HARQ process identifier in addition to the content included in the RAR UL grant.

In the NR system, for supporting ultra-reliable and low-latency communication (URLLC) services, transmission reliability is improved by employing repetition for transmission of uplink data.

For improving coverage performance of the Msg3 PUSCH, repetition for transmission of the Msg3 PUSCH is introduced, and the base station needs to indicate the number of repetitions for transmission of the Msg3 PUSCH. For example, for the initial transmission of the Msg3 PUSCH scheduled by the RAR UL grant, the number of repetitions for transmission is indicated by most significant two bits in an MCS information field in the RAR UL grant.

In a related art, four bits of the MCS information field in the RAR UL grant indicate the first 16 MCS indexes in the MCS table shown in Table 2.

TABLE 2

| MCS index | Modulation order | Target code rate | Spectral |
|---|---|---|---|
| (I_{MCS}) | (Qₘ) | (R × 1024) | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

With respect to the repetition for transmission of the Msg3 PUSCH, an MCS level adopted for transmission of the Msg3 PUSCH is limited as the size of the Msg3 is limited and the repetition for transmission of the Msg3 PUSCH is configured for a coverage enhancement scenario. Therefore, a portion of bits in the MCS information field indicates the number of repetitions for transmission of the Msg3 PUSCH.

In some scenarios, a portion of bits in a modulation and coding scheme (MCS) information field in scheduling information of a Msg3 PUSCH is considered to indicate the number of repetitions for transmission of the Msg3 PUSCH.

With respect to the initial transmission of the Msg3 PUSCH, the scheduling information of the Msg3 PUSCH is carried by the RAR UL grant, and the scheduling information includes a four-bit MCS information field. The most significant two bits in the four-bit MCS information field indicates four types of the number of repetitions for transmission, and the least significant two bits in the original MCS information field indicates the MCS index, in which case four MCS indexes are indicated. The most significant two bits of the MCS information field may indicate one type of the number of repetitions for transmission in a set including the four types of the number of repetitions. The number of repetitions set may be configured by the network device through a system message. In the case that the network device does not configure the number of repetitions, a default number of repetitions set may be {1, 2, 3, 4}.

With respect to the retransmission of the Msg3, the scheduling information of the Msg3 PUSCH is carried by the DCI format 0_0, wherein the CRC of the DCI format 0_0 is scrambled by the TC-RNTI. The scheduling information includes a five-bit MCS information field. Therefore, the numbers of bits in the MCS information field are different for the initial transmission and the retransmission of the Msg3 PUSCH. In this case, how to indicate the MCS index and/or the number of repetitions for transmission of the Msg3 PUSCH is an urgent problem to be solved.

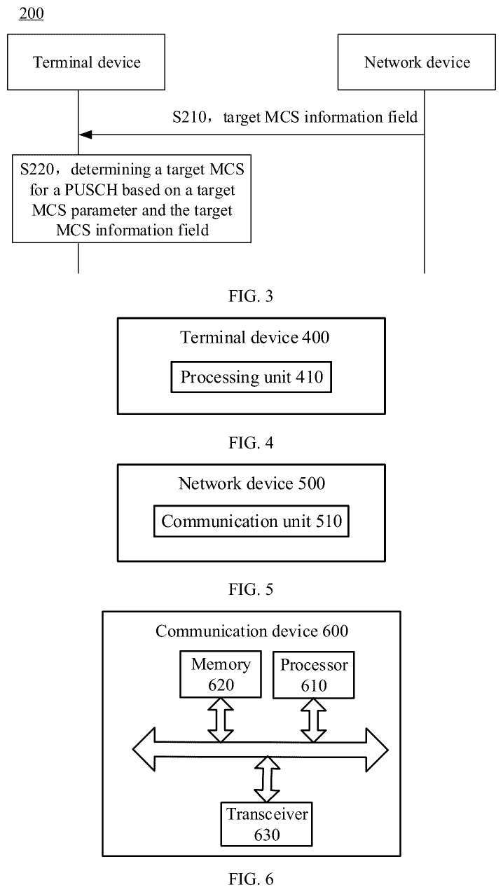

FIG. 3 is a schematic interaction diagram of a method 300 for wireless communication according to some embodiments of the present disclosure. As shown in FIG. 3, the method 300 includes at least some of the following processes.

In S210, a terminal device determines a target MCS for transmitting a physical uplink shared channel (PUSCH) based on a target MCS parameter and a target MCS information field, wherein the target MCS parameter indicates N MCS indexes, N being a positive integer greater than 1, and the PUSCH is configured to carry a message 3 (Msg3) in a random access process.

The terminal device can determine an MCS index for transmitting a Msg3 PUSCH. In the embodiments of the present disclosure, the PUSCH configured to carry the Msg3 may also be referred to as Msg3 PUSCH.

In some embodiments, the target MCS information field is a first MCS information field carried in an RAR uplink grant. The RAR UL grant is configured to schedule the initial transmission of the Msg3 PUSCH. That is, in the initial transmission scenario of the Msg3 PUSCH, the target MCS information field is the first MCS information field.

In some embodiments, the target MCS information field is a second information field carried in a DCI format 0_0 scrambled by a TC-RNTI. The DCI format 0_0 scrambled by the TC-RNTI is configured to schedule the retransmission of the Msg3 PUSCH. That is, in the retransmission scenario of the Msg3 PUSCH, the target MCS information field is the second MCS information field.

In some embodiments, the first MCS information field is four bits, and the second MCS information field is five bits.

In some embodiments, a portion of bits in the first MCS information field indicate the number of repetitions for transmission information for the initial transmission of the Msg3 PUSCH. For example, the most significant two bits in the first MCS information field indicate the number of repetitions for transmission information for the initial transmission of the Msg3 PUSCH.

In some embodiments, a portion of bits in the second MCS information field indicate the number of repetitions for transmission information for the retransmission of the Msg3 PUSCH. For example, the most significant two bits in the second MCS information field indicate the number of repetitions for transmission information for the retransmission of the Msg3 PUSCH.

In some embodiments, the terminal device determines a target number of repetitions for transmission based on the two bits in the first MCS information field or the second MCS information field and a target number of repetitions set. The target number of repetitions set includes K pieces of information about the number of repetitions. For example, K is 4.

In some embodiments, the two bits indicate an order of the target number of repetitions for transmission in the K pieces of information about the number of repetitions.

For example, a value 0 of the two bits indicates that the target number of repetitions for transmission is a first number of repetitions in the K pieces of information about the number of repetitions, and a value 1 indicates that the target number of repetitions for transmission is a second number of repetitions in the K pieces of information about the number of repetitions, and so on.

In some embodiments, the target number of repetitions set is one of X number of repetitions sets, wherein X is a positive integer.

In some embodiments, the target number of repetitions set is configured by the network device, for example, the target number of repetitions set is configured by a system message. For example, the target number of repetitions set is configured by PUSCH-common configuration information (pusch-ConfigCommon).

In some embodiments, X is 4.

In some embodiments, the X number of repetitions sets are predefined or configured by the network device, for example, the X number of repetitions sets are configured by a system message.

In other embodiments, in the case that the target number of repetitions set is not configured, the terminal device determines a target number of repetitions for transmission based on the two bits in the first MCS information field or the second MCS information field and a default number of repetitions set. The default number of repetitions set includes P pieces of information about the number of repetitions, wherein P is a positive integer.

For example, the default number of repetitions set is {1, 2, 3, 4}.

In some embodiments, the two bits indicate an order of a target number of repetitions for transmission in the P pieces of information about the number of repetitions.

For example, a value 0 of the two bits indicates that the target number of repetitions for transmission is a first number of repetitions in the P pieces of information about the number of repetitions, and a value 1 indicates that the target number of repetitions for transmission is a second number of repetitions in the P pieces of information about the number of repetitions, and so on.

In some embodiments, target bits in the first MCS information field (i.e., other bits in the first MCS information field than the two bits configured to indicate the number of repetitions for transmission, such as least significant two bits) are configured to determine the target MCS for initial transmission of the Msg3 PUSCH.

For example, the least significant two bits in the first MCS information field indicate four MCS indexes. The four MCS indexes may be configured by the network device through an MCS parameter for repetitions for transmission of the Msg3 (mcs-Msg3Repetition). In some embodiments, in the case that the mcs-Msg3Repetition is not configured, the four MCS indexes take default values of 0-3.

For example, a corresponding relationship between the value of the least significant two bits of the first MCS information field and the indicated four MCS indexes I_{MCS} is shown in Table 1 hereinafter.

TABLE 1

| mcs-Msg3Repetition | | mcs-Msg3Repetition | |
|---|---|---|---|
| is configured | | is not configured | |
| Code- | | Code- | |
| point | I_{MCS} | point | I_{MCS} |
| 00 | First value in the mcs-Msg3Repetition | 00 | 0 |
| 01 | Second value in the mcs-Msg3Repetition | 01 | 1 |
| 10 | Third value in the mcs-Msg3Repetition | 10 | 2 |
| 11 | Fourth value in the mcs-Msg3Repetition | 11 | 3 |

In some embodiments, at least a portion of target bits in the second MCS information field (i.e., other bits in the second MCS information field than the two bits configured to indicate the number of repetitions for transmission, such as least significant three bits) are configured to determine the target MCS for retransmission of the Msg3 PUSCH. That is, in the retransmission scenario of the Msg3 PUSCH, at most eight MCS indexes can be indicated. In this case, how to indicate the target MCS for retransmission of the Msg3 PUSCH is an urgent problem to be solved.

Hereinafter, a method for determining the target MCS for retransmission of the PUSCH are described with reference to specific implementation of the target MCS parameter.

It is understandable that, in the embodiments of the present disclosure, the network device and the terminal device have the same understanding on the target MCS. For example, the network device indicates the target MCS index to the terminal device by setting a value of target bits in the target MCS information field based on the target MCS parameter, and correspondingly, the terminal device determines the target MCS index indicated by the network device by interpreting the value of the target bits in the target MCS information field based on the target MCS parameter.

### Embodiment 1

In the Embodiment 1, an MCS index set dedicated to retransmission of the Msg3 PUSCH is designed.

In this way, in the retransmission scenario of the Msg3 PUSCH, the terminal device determines the target MCS for retransmission of the Msg3 PUSCH based on the target bits in the MCS information field and the MCS index set for retransmission of the Msg3 PUSCH.

### Embodiment 1-1

In some embodiments of the present disclosure, the target MCS parameter includes a first MCS parameter, wherein the first MCS parameter is an MCS parameter dedicated to retransmission of the PUSCH. For case of differentiation and illustration, the first MCS parameter is denoted as mcs-Msg3Repetition-Re-1.

In some embodiments, the first MCS parameter is configured by the network device, for example, through radio resource control (RRC) signaling.

In some embodiments, the number of MCS indexes indicated by the first MCS parameter is determined based on the number of MCS indexes that can be indicated by the target bits in the second MCS information field.

In some embodiments, the target bits are three bits, and the first MCS parameter indicates eight MCS indexes.

In some embodiments of the present disclosure, S210 includes:
determining the target MCS for retransmission of the PUSCH based on target bits (for example, least significant three bits) in the first MCS information field and the eight MCS indexes indicated by the first MCS parameter, wherein the three bits indicate a target MCS index in the eight MCS indexes.

For example, the MCS indicated by the target MCS index is the target MCS for retransmission of the Msg3 PUSCH.

In some embodiments, a value of the target bits indicates an order of the target MCS index in the eight MCS indexes.

For example, a value 000 of the target bits indicates that the target MCS index is a first MCS index in the eight MCS indexes, a value 001 indicates that the target MCS index is a second MCS index in the eight MCS indexes, a value 010 indicates that the target MCS index is a third MCS index in the eight MCS indexes, and so on.

### Embodiment 1-2

In other embodiments of the present disclosure, the target MCS parameter includes a first default MCS parameter, wherein the first default MCS parameter is a default MCS parameter dedicated to retransmission of the PUSCH.

In the embodiments, the initial transmission and the retransmission of the Msg3 PUSCH adopt independent default MCS parameters.

In some embodiments, the default MCS parameter for the initial transmission of the Msg3 PUSCH indicates four MCS indexes, wherein the four MCS indexes have default values of 0 to 3.

In some embodiments, the number of MCS indexes indicated by the first default MCS parameter is determined based on the number of MCS indexes that can be indicated by the target bits in the second MCS information field.

In some embodiments, the target bits are three bits, and the first default MCS parameter indicates eight MCS indexes. For example, the eight MCS indexes have values ranging from 0 to 7.

In some embodiments of the present disclosure, S210 includes:
in the case that the first MCS parameter is not configured, determining the target MCS for retransmission of the PUSCH based on target bits (for example, least significant three bits) in the first MCS information field and the eight MCS indexes indicated by the first default MCS parameter, wherein the three bits indicate a target MCS index in the eight MCS indexes.

For example, the MCS indicated by the target MCS index is the target MCS for retransmission of the PUSCH.

In some embodiments, the target bits indicate an order of the target MCS index in the eight MCS indexes indicated by the first default MCS parameter.

For example, the first default MCS parameter indicates MCS indexes 0 to 7, a value 000 of the target bits indicates that the target MCS index is the MCS index 0 in the eight MCS indexes indicated by the first default MCS parameter, a value 001 indicates that the target MCS index is the MCS index 1 in the eight MCS indexes indicated by the first default MCS parameter, a value 010 indicates that the target MCS index is the MCS index 2 in the eight MCS indexes indicated by the first default MCS parameter, and so on.

By way of example and not limitation, a corresponding relationship between the value of the least significant three bits of the second MCS information field and the indicated eight MCS indexes I_{MCS} is shown in Table 2.

TABLE 2

| mcs-Msg3Repetition-Re-1 is configured | | mcs-Msg3Repetition-Re-1 is not configured | |
|---|---|---|---|
| Codepoint | I_{MCS} | Codepoint | I_{MCS} |
| 000 | First value in the mcs-Msg3Repetition-Re-1 | 000 | 0 |
| 001 | Second value in the mcs-Msg3Repetition-Re-1 | 001 | 1 |
| 010 | Third value in the mcs-Msg3Repetition-Re-1 | 010 | 2 |
| 011 | Fourth value in the mcs-Msg3Repetition-Re-1 | 011 | 3 |
| 100 | Fifth value in the mcs-Msg3Repetition-Re-1 | 100 | 4 |
| 101 | Sixth value in the mcs-Msg3Repetition-Re-1 | 101 | 5 |
| 110 | Seventh value in the mcs-Msg3Repetition-Re-1 | 110 | 6 |
| 111 | Eighth value in the mcs-Msg3Repetition-Re-1 | 111 | 7 |

### Embodiment 2

In some embodiments, in Embodiment 2, the MCS index sets for initial transmission and retransmission of the Msg3 PUSCH are the same set, and the number of MCS indexes included in the MCS index set is determined based on the number of MCS indexes that can be indicated by the retransmission of the Msg3 PUSCH. In this way, the network device does not need to configure a dedicated MCS index set for the retransmission of the Msg3 PUSCH, which is beneficial to reducing signaling overhead.

For example, in the initial transmission scenario of the Msg3 PUSCH, two bits in the first MCS information field indicate MCS indexes for initial transmission of the Msg3 PUSCH, and at most four MCS indexes can be indicated.

For another example, in the retransmission scenario of the Msg3 PUSCH, three bits in the second MCS information field indicate MCS indexes for retransmission of the Msg3 PUSCH, and at most eight MCS indexes can be indicated.

Therefore, a MCS index set for initial transmission and retransmission of the Msg3 PUSCH may be designed to indicate eight MCS indexes.

### Embodiment 2-1

In some embodiments of the present disclosure, the target MCS parameter includes a second MCS parameter, wherein the second MCS parameter is an MCS parameter for initial transmission and retransmission of the PUSCH. The second MCS parameter is denoted as mcs-Msg3Repetition-Re-2.

In some embodiments, the second MCS parameter is configured by the network device, for example, the second MCS parameter is configured by RRC signaling.

In some embodiments, the second MCS parameter indicates eight MCS indexes.

In some embodiments, for the retransmission of the Msg3 PUSCH, S210 includes:
determining the target MCS for retransmission of the PUSCH based on target bits (for example, least significant three bits) in the second MCS information field and the eight MCS indexes indicated by the second MCS parameter, wherein the target bits indicate a target MCS index in the eight MCS indexes.

For example, the MCS indicated by the target MCS index is the target MCS for retransmission of the PUSCH.

In some embodiments, the target bits indicate an order of the target MCS index in the eight MCS indexes.

For example, a value 000 of the target bits indicates that the target MCS index is a first MCS index in the eight MCS indexes, a value 001 indicates that the target MCS index is a second MCS index in the eight MCS indexes, a value 010 indicates that the target MCS index is a third MCS index in the eight MCS indexes, and so on.

In some embodiments, with respect to the initial transmission of the Msg3 PUSCH, the terminal device uses only four MCS indexes, by way of example and not limitation, first four MCS indexes, in the eight MCS indexes indicated by the second MCS parameter.

In some embodiments, for the initial transmission of the Msg3 PUSCH, S210 includes:
determining the target MCS for initial transmission of the PUSCH based on target bits (for example, least significant two bits) in the first MCS information field and first four MCS indexes in the eight MCS indexes indicated by the second MCS parameter, wherein the target bits indicate a target MCS index in the first four MCS indexes.

For example, the MCS indicated by the target MCS index is the target MCS for initial transmission of the PUSCH.

In some embodiments, a value of the target bits indicates an order of the target MCS index in the first four MCS indexes. For example, a value 00 of the target bits indicates that the target MCS index is a first MCS index in the first four MCS indexes, a value 01 indicates that the target MCS index is a second MCS index in the first four MCS indexes, a value 10 indicates that the target MCS index is a third MCS index in the first four MCS indexes, and so on.

### Embodiment 2-2

In other embodiments of the present disclosure, the target MCS parameter includes a second default MCS parameter, wherein the second default MCS parameter is a default MCS parameter for initial transmission and retransmission of the PUSCH.

In the embodiments, the initial transmission and the retransmission of the Msg3 PUSCH adopt the same default MCS parameter.

In some embodiments, the second default MCS parameter indicates eight MCS indexes. For example, the eight MCS indexes have values ranging from 0 to 7.

In some embodiments, for the retransmission of the Msg3 PUSCH, S210 includes:
in the case that the second MCS parameter is not configured, determining the target MCS for retransmission of the PUSCH based on target bits (for example, least significant three bits) in the second MCS information field and the eight MCS indexes indicated by the second default MCS parameter, wherein the target bits indicate a target MCS index in the eight MCS indexes.

For example, the MCS indicated by the target MCS index is the target MCS for retransmission of the PUSCH.

In some embodiments, the target bits indicate an order of the target MCS index in the eight MCS indexes.

For example, the second default MCS parameter indicates MCS indexes 0 to 7, a value 000 of the target bits indicates that the target MCS index is the MCS index 0 in the eight MCS indexes, a value 001 indicates that the target MCS index is the MCS index 1 in the eight MCS indexes, a value 010 indicates that the target MCS index is the MCS index 2 in the eight MCS indexes, and so on.

In some embodiments, with respect to the initial transmission of the Msg3 PUSCH, the terminal device utilizes only four MCS indexes, for example, first four MCS indexes, in the eight MCS indexes indicated by the second default MCS parameter.

In some embodiments, for the initial transmission of the Msg3 PUSCH, S210 includes:
determining the target MCS for initial transmission of the PUSCH based on target bits (for example, least significant two bits) in the first MCS information field and first four MCS indexes in the eight MCS indexes indicated by the second default MCS parameter, wherein the two bits indicate a target MCS index in the first four MCS indexes.

For example, the second default MCS parameter indicates MCS indexes 0 to 7, a value 00 of the two bits indicates that the target MCS index is the MCS index 0 in the first four MCS indexes, a value 01 indicates that the target MCS index is the MCS index 1 in the first four MCS indexes, a value 10 indicates that the target MCS index is the MCS index 2 in the first four MCS indexes, and so on.

By way of example and not limitation, corresponding relationships between the values of the least significant two bits in the first MCS information field and the least significant three bits of the second MCS information field and the indicated eight MCS indexes I_{MCS} are shown in Table 3.

TABLE 3

| mcs-Msg3Repetition-2 is configured | | | mcs-Msg3Repetition is not configured | |
|---|---|---|---|---|
| Codepoint | | I_{MCS} | Codepoint | I_{MCS} |
| 00 | 000 | First value in the mcs-Msg3Repetition-2 | 000 | 0 |
| 01 | 001 | Second value in the mcs-Msg3Repetition-2 | 001 | 1 |
| 10 | 010 | Third value in the mcs-Msg3Repetition-2 | 010 | 2 |
| 11 | 011 | Fourth value in the mcs-Msg3Repetition-2 | 011 | 3 |
| — | 100 | Fifth value in the mcs-Msg3Repetition-2 | 100 | 4 |
| — | 101 | Sixth value in the mcs-Msg3Repetition-2 | 101 | 5 |
| — | 110 | Seventh value in the mcs-Msg3Repetition-2 | 110 | 6 |
| — | 111 | Eighth value in the mcs-Msg3Repetition-2 | 111 | 7 |

### Embodiment 3

In some embodiments, in Embodiment 3, the MCS index sets for initial transmission and retransmission of the Msg3 PUSCH are the same set, and the number of MCS indexes included in the MCS index set is determined based on the number of MCS indexes required to indicate for the initial transmission of the Msg3 PUSCH. In this way, the network device does not need to configure a dedicated MCS index set for the retransmission of the Msg3 PUSCH.

In some embodiments, the target MCS parameter includes a third MCS parameter, wherein the third MCS parameter is an MCS parameter for initial transmission and retransmission of the PUSCH. The third MCS parameter is denoted as mcs-Msg3Repetition-3.

In some embodiments, the third MCS parameter indicates four MCS indexes.

### Embodiment 3-1: the Retransmission Scenario of the Msg3 PUSCH Requires Indication of Eight MCS Indexes

In some embodiments of the present disclosure, S210 includes:
determining the target MCS for retransmission of the PUSCH based on target bits (for example, least significant three bits) in the second MCS information field and the four MCS indexes indicated by the third MCS parameter.

In some embodiments, the three bits indicate eight MCS indexes, wherein four MCS indexes in the eight MCS indexes are determined directly based on the MCS indexes indicated by the third MCS parameter, and the other four MCS indexes are determined based on at least one of the four MCS indexes indicated by the third MCS parameter and a specific offset.

For example, first four MCS indexes (i.e., first to fourth MCS indexes) in the eight MCS indexes correspond to the four MCS indexes indicated by the third MCS parameter, and last four MCS indexes (i.e., fifth to eighth MCS indexes) in the eight MCS indexes are determined based on at least one of the four MCS indexes indicated by the third MCS parameter.

In some embodiments, the first four MCS indexes refer to MCS indexes indicated by the three bits with values of 000 to 011, and the last four MCS indexes refer to MCS indexes indicated by the three bits with values of 100 to 111.

For example, the last four MCS indexes in the eight MCS indexes are determined based on the fourth MCS index in the four MCS indexes indicated by the third MCS parameter and four different offsets, wherein each of the four offsets corresponds to one of the last four MCS indexes. That is, the last four MCS indexes may be determined by adding different offsets to the fourth MCS index. For example, the four offsets are 1, 2, 3, and 4, respectively. That is, the fifth to eighth MCS indexes may be acquired by adding 1, 2, 3, and 4 to the fourth MCS index, respectively.

In other embodiments of the present disclosure, S210 includes:
determining the target MCS for retransmission of the PUSCH based on two bits in target bits (for example, least significant three bits) in the second MCS information field and the four MCS indexes indicated by the third MCS parameter.

In some embodiments, another one bit in the target bits except the two bits is an idle bit.

In other embodiments, the another one bit and two other bits except the three bits in the MCS information field indicate a target number of repetitions for transmission of the PUSCH. In this case, the target number of repetitions set includes eight pieces of information about the number of repetitions.

In some embodiments, the target number of repetitions set including eight pieces of information about the number of repetitions is configured by the network device through a system message.

In some embodiments, in the case that the network device does not configure the target number of repetitions set, the target number of repetitions set is determined using a default number of repetitions set, wherein the default number of repetitions set includes eight pieces of information about the number of repetitions. For example, the default number of repetitions set is {1, 2, 3, 4, 7, 8, 12, 16}.

### Embodiment 3-2

In some embodiments, the target MCS parameter includes a third default MCS parameter, wherein the third default MCS parameter is a default MCS parameter for initial transmission and retransmission of the PUSCH.

That is, in the embodiments, the initial transmission and the retransmission of the Msg3 PUSCH adopt the same default MCS parameter.

In some embodiments, the third default MCS parameter indicates eight MCS indexes, wherein the eight MCS indexes have values ranging from 0 to 7.

In some embodiments, for the retransmission of the Msg3 PUSCH, S210 includes:
in the case that the third MCS parameter is not configured, determining the target MCS for retransmission of the PUSCH based on target bits (for example, least significant three bits) in the second MCS information field and the eight MCS indexes indicated by the third default MCS parameter, wherein the target bits indicate a target MCS index in the eight MCS indexes.

For example, the MCS indicated by the target MCS index is the target MCS for retransmission of the PUSCH.

In some embodiments, a value of the target bits indicates an order of the target MCS index in the eight MCS indexes.

For example, the third default MCS parameter indicates MCS indexes 0 to 7, a value 000 of the target bits indicates that the target MCS index is the MCS index 0 in the eight MCS indexes, a value 001 indicates that the target MCS index is the MCS index 1 in the eight MCS indexes, a value 010 indicates that the target MCS index is the MCS index 2 in the eight MCS indexes, and so on.

In some embodiments, with respect to the initial transmission of the Msg3 PUSCH, the terminal device utilizes only four MCS indexes, for example, first four MCS indexes, in the eight MCS indexes indicated by the third default MCS parameter.

In some embodiments, for the initial transmission of the Msg3 PUSCH, S210 includes:
determining the target MCS for initial transmission of the PUSCH based on target bits (for example, least significant two bits) in the first MCS information field and first four MCS indexes in the eight MCS indexes indicated by the third default MCS parameter, wherein the two bits indicate the target MCS index in the first four MCS indexes.

For example, the third default MCS parameter indicates MCS indexes 0 to 7, a value 00 of the two bits indicates that the target MCS index is the MCS index 0 in the first four MCS indexes, a value 01 indicates that the target MCS index is the MCS index 1 in the first four MCS indexes, a value 10 indicates that the target MCS index is the MCS index 2 in the first four MCS indexes, and so on.

### Embodiment 3-3

In some embodiments, the target MCS parameter includes a fourth default MCS parameter, wherein the fourth default MCS parameter is a default MCS parameter for retransmission of the PUSCH.

That is, in the embodiments, the initial transmission and the retransmission of the Msg3 PUSCH adopt independent default MCS parameters.

In some embodiments, the fourth default MCS parameter indicates eight MCS indexes, wherein the eight MCS indexes have values ranging from 0 to 7.

In some embodiments, the default MCS parameter for the initial transmission of the Msg3 PUSCH indicates four MCS indexes, wherein the four MCS indexes have default values of 0 to 3.

In some embodiments, for the retransmission of the Msg3 PUSCH, S210 includes:
in the case that the third MCS parameter is not configured, determining the target MCS for retransmission of the PUSCH based on target bits (for example, least significant three bits) in the second MCS information field and the eight MCS indexes indicated by the fourth default MCS parameter, wherein the target bits indicate a target MCS index in the eight MCS indexes.

For example, the MCS indicated by the target MCS index is the target MCS for retransmission of the PUSCH.

In some embodiments, a value of the target bits indicates an order of the target MCS index in the eight MCS indexes.

For example, the fourth default MCS parameter indicates MCS indexes 0 to 7, a value 000 of the target bits indicates that the target MCS index is the MCS index 0 in the eight MCS indexes, a value 001 indicates that the target MCS index is the MCS index 1 in the eight MCS indexes, a value 010 indicates that the target MCS index is the MCS index 2 in the eight MCS indexes, and so on.

### Embodiment 3-4

In some embodiments, the target MCS parameter includes a fifth default MCS parameter, wherein the fifth default MCS parameter is a default MCS parameter for initial transmission and retransmission of the PUSCH.

In the embodiments, the initial transmission and the retransmission of the Msg3 PUSCH adopt the same default MCS parameter.

In some embodiments, the fifth default MCS parameter indicates four MCS indexes, wherein the four MCS indexes have values ranging from 0 to 4.

In some embodiments of the present disclosure, for the retransmission of the Msg3 PUSCH, S210 includes:
in the case that the third MCS parameter is not configured, determining the target MCS for retransmission of the PUSCH based on target bits (for example, least significant three bits) in the second MCS information field and the four MCS indexes indicated by the fifth default MCS parameter, wherein the target bits indicate a target MCS index in the four MCS indexes. For a specific method for determination, reference is made to the implementation related to determining the target MCS based on the third MCS parameter in Embodiment 3-1, which is not repeated herein for brevity.

In other embodiments of the present disclosure, for the retransmission of the Msg3 PUSCH, S210 includes:
in the case that the third MCS parameter is not configured, determining the target MCS for retransmission of the PUSCH based on two bits in target bits (for example, least significant three bits) in the second MCS information field and the four MCS indexes indicated by the fifth default MCS parameter.

In some embodiments, another one bit in the target bits except the two bits is an idle bit.

In other embodiments, the another one bit and two other bits except the three bits in the MCS information field indicate a target number of repetitions for transmission of the PUSCH. In this case, the target number of repetitions set includes eight pieces of information about the number of repetitions.

In some embodiments, the target number of repetitions set including eight pieces of information about the number of repetitions is configured by the network device through a system message.

In some embodiments, in the case that the network device does not configure the target number of repetitions set, the target number of repetitions for transmission is determined using a default number of repetitions set, wherein the default number of repetitions set includes eight pieces of information about the number of repetitions. For example, the default number of repetitions set is {1, 2, 3, 4, 7, 8, 12, 16}.

It is understandable that the design of the default MCS parameter in Embodiment 3 is also applicable to Embodiments 1 and 2 described above. For example, in the case that the parameter configured by the network device is the first MCS parameter or the second MCS parameter, the default MCS parameter for initial transmission or retransmission of the PUSCH may adopt any one of Embodiments 3-2 to 3-4, which is not limited in the present disclosure.

For example, the target MCS parameter is the third MCS parameter or the third default MCS parameter or the fourth default MCS parameter, corresponding relationships between the values of the least significant two bits in the first MCS information field and the least significant three bits of the second MCS information field and the indicated eight MCS indexes I_{MCS} are shown in Table 4.

TABLE 4

| mcs-Msg3Repetition-3 is configured | | | mcs-Msg3Repetition-3 is not configured | |
|---|---|---|---|---|
| Codepoint | | I_{MCS} | Codepoint | I_{MCS} |
| 00 | 000 | First value in the mcs-Msg3Repetition-3 | 000 | 0 |
| 01 | 001 | Second value in the mcs-Msg3Repetition-3 | 001 | 1 |
| 10 | 010 | Third value in the mcs-Msg3Repetition | 010 | 2 |
| 11 | 011 | Fourth value in the mcs-Msg3Repetition | 011 | 3 |
| — | 100 | Fourth value in the mcs-Msg3Repetition + 1 | 100 | 4 |
| — | 101 | Fourth value in the mcs-Msg3Repetition + 2 | 101 | 5 |
| — | 110 | Fourth value in the mcs-Msg3Repetition + 3 | 110 | 6 |
| — | 111 | Fourth value in the mcs-Msg3Repetition + 4 | 111 | 7 |

Therefore, in the embodiments of the present disclosure, an independent MCS parameter or default MCS parameter may be configured for the retransmission of the Msg3 PUSCH, or a common MCS parameter or default MCS parameter may be configured for the retransmission and the initial transmission of the Msg3 PUSCH. Further, the target MCS may be determined based on the MCS information field corresponding to the retransmission of the Msg3 PUSCH in combination with the MCS parameter or default MCS parameter, which is beneficial to implementing repetition for transmission of the PUSCH carrying the Msg3, thereby improving the transmission performance of the Msg3.

The method embodiments of the present disclosure have been described in detail above with reference to FIG. 3, and apparatus embodiments of the present disclosure are described in detail hereinafter with reference to FIG. 4 to FIG. 8. It is understandable that the apparatus embodiments correspond to the method embodiments and that reference is made to the method embodiments for similar descriptions.

FIG. 4 shows a schematic block diagram of a terminal device 400 according to some embodiments of the present disclosure. As shown in FIG. 4, the terminal device 400 includes:
a processing unit 410, configured to determine a target modulation and coding scheme (MCS) for transmitting a physical uplink shared channel (PUSCH) based on a target MCS parameter and a target MCS information field, wherein the target MCS parameter indicates N MCS indexes, N being a positive integer greater than 1, and the PUSCH is configured to carry a message 3 (Msg3) in a random access process.

In some embodiments, for initial transmission of the PUSCH, the target MCS information field is a first MCS information field carried in a random access response (RAR) uplink grant; or
for retransmission of the PUSCH, the target MCS information field is a second MCS information field carried in a downlink control information (DCI) format 0_0 scrambled by a temporary cell radio network temporary identifier (TC-RNTI).

In some embodiments, the target MCS parameter includes a first MCS parameter or a first default MCS parameter, wherein the first MCS parameter is an MCS parameter dedicated to retransmission of the PUSCH, and the first default MCS parameter is a default MCS parameter dedicated to retransmission of the PUSCH.

In some embodiments, the first MCS parameter indicates eight MCS indexes.

In some embodiments, the first default MCS parameter indicates eight MCS indexes, wherein the eight MCS indexes have values ranging from 0 to 7.

In some embodiments, the processing unit 410 is further configured to:
determine the target MCS for retransmission of the PUSCH based on three bits in the second MCS information field and the eight MCS indexes indicated by the first MCS parameter, wherein the three bits indicate a target MCS index in the eight MCS indexes; or
determine, in the case that the first MCS parameter is not configured, the target MCS for retransmission of the PUSCH based on three bits in the second MCS information field and the eight MCS indexes indicated by the first default MCS parameter, wherein the three bits indicate a target MCS index in the eight MCS indexes.

In some embodiments, the target MCS parameter includes a second MCS parameter or a second default MCS parameter, wherein the second MCS parameter is an MCS parameter for initial transmission and retransmission of the PUSCH, and the second default MCS parameter is a default MCS parameter for initial transmission and retransmission of the PUSCH.

In some embodiments, the second MCS parameter indicates eight MCS indexes.

In some embodiments, the second default MCS parameter is indicates eight MCS indexes, wherein the eight MCS indexes have values ranging from 0 to 7.

In some embodiments, the processing unit 410 is further configured to:
determine the target MCS for retransmission of the PUSCH based on three bits in the second MCS information field and the eight MCS indexes indicated by the second MCS parameter, wherein the three bits indicate a target MCS index in the eight MCS indexes; or
determine, in the case that the second MCS parameter is not configured, the target MCS for retransmission of the PUSCH based on three bits in the second MCS information field and the eight MCS indexes indicated by the second default MCS parameter, wherein the three bits indicate a target MCS index in the eight MCS indexes.

In some embodiments, the processing unit 410 is further configured to:
determine the target MCS for initial transmission of the PUSCH based on two bits in the first MCS information field and first four MCS indexes in the eight MCS indexes indicated by the second MCS parameter, wherein the two bits indicate a target MCS index in the first four MCS indexes; or
determine, in the case that the second MCS parameter is not configured, the target MCS for initial transmission of the PUSCH based on two bits in the first MCS information field and first four MCS indexes in the eight MCS indexes indicated by the second default MCS parameter, wherein the two bits indicate a target MCS index in the first four MCS indexes.

In some embodiments, the target MCS parameter includes a third MCS parameter, a third default MCS parameter, or a fourth default MCS parameter, wherein the third MCS parameter is an MCS parameter for initial transmission and retransmission of the PUSCH, the third default MCS parameter is a default MCS parameter for initial transmission and retransmission of the PUSCH, or the fourth default MCS parameter is a default MCS parameter dedicated to retransmission of the PUSCH.

In some embodiments, the third MCS parameter indicates four MCS indexes.

In some embodiments, the third default MCS parameter indicates eight MCS indexes, wherein the eight MCS indexes have values ranging from 0 to 7; or
the fourth default MCS parameter indicates eight MCS indexes, wherein the eight MCS indexes have values ranging from 0 to 7.

In some embodiments, the processing unit 410 is further configured to:
determine the target MCS for retransmission of the PUSCH based on three bits in the second MCS information field and the four MCS indexes indicated by the third MCS parameter; or
determine, in the case that the third MCS parameter is not configured, the target MCS for retransmission of the PUSCH based on three bits in the second MCS information field and the eight MCS indexes indicated by the third default MCS parameter or the fourth default MCS parameter.

In some embodiments, the three bits indicate eight MCS indexes, wherein first four MCS indexes in the eight MCS indexes correspond to the four MCS indexes indicated by the third MCS parameter, and last four MCS indexes in the eight MCS indexes are determined based on at least one of the four MCS indexes indicated by the third MCS parameter.

In some embodiments, the last four MCS indexes in the eight MCS indexes are determined based on a fourth MCS index in the four MCS indexes indicated by the third MCS parameter and four different offsets, wherein each of the four offsets corresponds to one of the last four MCS indexes.

In some embodiments, the processing unit 410 is further configured to:
determine the target MCS for retransmission of the PUSCH based on two bits in three bits in the second MCS information field and the four MCS indexes indicated by the third MCS parameter; or
determine, in the case that the third MCS parameter is not configured, the target MCS for retransmission of the PUSCH based on two bits in three bits in the second MCS information field and the eight MCS indexes indicated by the third default MCS parameter or the fourth default MCS parameter.

In some embodiments, another one bit in the three bits except the two bits is an idle bit, or the another one bit and two other bits except the three bits in the MCS information field indicate a target number of repetitions for transmission of the PUSCH, wherein the target number of repetitions belongs to a target number of repetitions set or a default number of repetitions set, the target number of repetitions set including eight pieces of information about the number of repetitions, and the default number of repetitions set includes eight pieces of information about the number of repetitions.

In some embodiments, the three bits are least significant three bits in the second MCS information field.

In some embodiments, the two bits are least significant two bits in the first MCS information field.

In some embodiments, the above communication unit is a communication interface or a transceiver, or an input/output interface of a communication chip or an on-chip system. The above processing unit is one or more processors.

It is understandable that the terminal device 400 according to the embodiments of the present disclosure may correspond to the terminal device in the method embodiments of the present disclosure, and the above and other operations and/or functions of the units in the terminal device 400 are separately for implementing corresponding flows of the terminal device in the method 300 shown in FIG. 3, which is not repeated herein for brevity.

FIG. 5 is a schematic block diagram of a network device according to some embodiments of the present disclosure. The network device 500 of FIG. 5 includes:
a communication unit 510, configured to transmit a target modulation and coding scheme (MCS) parameter to a terminal device, wherein the target MCS parameter is configured to determine a target MCS for transmitting a physical uplink shared channel (PUSCH), the target MCS parameter indicates N MCS indexes, N being a positive integer greater than 1, and the PUSCH is configured to carry a message 3 (Msg3) in a random access process.

In some embodiments, the target MCS is determined based on the target MCS parameter and a target MCS information field, wherein for initial transmission of the PUSCH, the target MCS information field is a first MCS information field carried in a random access response (RAR) uplink grant, or for retransmission of the PUSCH, the target MCS information field is a second MCS information field carried in a downlink control information (DCI) format 0_0 scrambled by a temporary cell radio network temporary identifier (TC-RNTI).

In some embodiments, the target MCS parameter includes a first MCS parameter, wherein the first MCS parameter is an MCS parameter dedicated to retransmission of the PUSCH.

In some embodiments, the first MCS parameter indicates eight MCS indexes.

In some embodiments, the target MCS parameter includes a second MCS parameter, wherein the second MCS parameter is an MCS parameter for initial transmission and retransmission of the PUSCH.

In some embodiments, the second MCS parameter indicates eight MCS indexes.

In some embodiments, the target MCS parameter includes a third MCS parameter, wherein the third MCS parameter is an MCS parameter for initial transmission and retransmission of the PUSCH.

In some embodiments, the third MCS parameter indicates four MCS indexes.

In some embodiments, the above communication unit is a communication interface or a transceiver, or an input/output interface of a communication chip or an on-chip system. The above processing unit is one or more processors.

It is understandable that the network device 500 according to the embodiments of the present disclosure may correspond to the network device in the method embodiments of the present disclosure, and the above and other operations and/or functions of the units in the network device 500 are separately for implementing corresponding flows of the network device in the method 300 shown in FIG. 3, which is not repeated herein for brevity.

FIG. 6 is a schematic structural diagram of a communication device 600 according to some embodiments of the present disclosure. The communication device 600 shown in FIG. 6 includes a processor 610. The processor 610, when loading and running a computer program from a memory, is caused to perform the methods in the embodiments of the present disclosure.

In some embodiments, as shown in FIG. 6, the communication device 600 further includes a memory 620. The processor 610 loads and runs the computer program from the memory 620 to perform the methods in the embodiments of the present disclosure.

The memory 620 may be a device independent from the processor 610 or the memory 620 may be integrated within the processor 610.

In some embodiments, as shown in FIG. 6, the communication device 600 further includes a transceiver 630. The processor 610 controls the transceiver 630 to communicate with other devices. For example, the processor 610 controls the transceiver 630 to transmit information or data to other devices, or to receive information or data transmitted by other devices.

In some embodiments, the transceiver 630 includes a transmitter and a receiver. The transceiver 630 may further include one or more antennas.

In some embodiments, the communication device 600 is the network device of the embodiments of the present disclosure, and the communication device 600 performs corresponding flows performed by the network device in various methods of the embodiments of the present disclosure, which is not repeated herein for brevity.

In some embodiments, the communication device 600 is the mobile terminal/terminal device of the embodiments of the present disclosure, and the communication device 600 performs corresponding flows performed by the mobile terminal/terminal device in various methods of the embodiments of the present disclosure, which is not repeated herein for brevity.

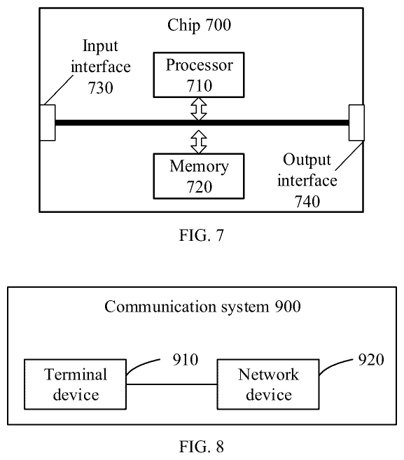

FIG. 7 is a schematic structural diagram of a chip according to some embodiments of the present disclosure. The chip 700 shown in FIG. 7 includes a processor 710. The processor 710, when loading and running a computer program from a memory, is caused to perform the methods in the embodiments of the present disclosure.

In some embodiments, as shown in FIG. 7, the chip 700 further includes a memory 720. The processor 710 loads and runs the computer program from the memory 720 to perform the methods in the embodiments of the present disclosure.

The memory 720 may be a device independent from the processor 710 or the memory 720 may be integrated within the processor 710.

In some embodiments, the chip 700 further includes an input interface 730. The processor 710 controls the input interface 730 to communicate with other devices or chips. For example, the processor 710 controls the input interface 730 to acquire information or data transmitted by other devices or chips.

In some embodiments, the chip 700 further includes an output interface 740. The processor 710 controls the output interface 740 to communicate with other devices or chips. For example, the processor 710 controls the output interface 740 to output information or data to other devices or chips.

In some embodiments, the chip is applicable to the network device in the embodiments of the present disclosure, and the chip performs corresponding flows performed by the network device in various methods of the embodiments of the present disclosure, which is not repeated herein for brevity.

In some embodiments, the chip is applicable to the mobile terminal/terminal device in the embodiments of the present disclosure, and the chip performs corresponding flows performed by the mobile terminal/terminal device in various methods of the embodiments of the present disclosure, which is not repeated herein for brevity.

It is understandable that the chip mentioned in the embodiments of the present disclosure may also be referred to as system-on-chip, system chip, chip system, or on-chip system.

FIG. 8 is a schematic block diagram of a communication system 900 according to some embodiments of the present disclosure. As shown in FIG. 8, the communication system 900 includes a terminal device 910 and a network device 920.

The terminal device 910 is configured to implement corresponding functions implemented by the terminal device in the above methods, and the network device 920 is configured to implement corresponding functions implemented by the network device in the above methods, which is not repeated herein for brevity.

It is understandable that the processor of the embodiments of the present disclosure may be an integrated circuit chip with signal processing capabilities. In implementation, the processes of the above method embodiments may be performed by hardware integrated logic circuits or software instructions in the processor. The above processor may be a general-purpose processor, a digital signal processor (DSP), an application specific integrated circuit (ASIC), a field programmable gate array (FPGA), or another programmable logic device, discrete gate or transistor logic device, or discrete hardware component. The above processor can implement or perform the methods, processes, and logic block diagrams disclosed in the embodiments of the present disclosure. The general-purpose processor may be a microprocessor or the processor may be any conventional processor or the like. The processes of the methods disclosed in connection with the embodiments of the present disclosure may be directly embodied as hardware and performed by a decoding processor, or performed by a combination of hardware and software modules in the decoding processor. The software module may be located in a random access memory, a flash memory, a read-only memory, a programmable read-only memory, an electrically erasable programmable memory, a register, or other mature storage medium in the art. The storage medium is located in a memory, and the processor reads information in the memory to perform the processes of the above methods in combination with the hardware of the memory.

It is understandable that the memory in the embodiments of the present disclosure may be either a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM) which serves as an external cache. By way of example and not limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memory of the systems and methods described herein is intended to include, but not limited to, these and any other suitable types of memories.

It is understandable that the above-mentioned memories are exemplary but not limiting. For example, the memory in the embodiments of the present disclosure can also be an SRAM, a DRAM, an SDRAM, a DDR SDRAM, an ESDRAM, an SLDRAM, and a DR RAM, or the like. That is, the memory in the embodiments of the present disclosure is intended to include, but not limited to, these and any other suitable types of memories.

A computer-readable storage medium is provided in the embodiments of the present disclosure. The computer-readable storage medium is configured to store a computer program.

In some embodiments, the computer-readable storage medium is applicable to the network device in the embodiments of the present disclosure, and the computer program, when loaded and run on a computer, causes the computer to perform corresponding flows performed by the network device in various methods of the embodiments of the present disclosure, which is not repeated herein for brevity.

In some embodiments, the computer-readable storage medium is applicable to the mobile terminal/terminal device in the embodiments of the present disclosure, and the computer program, when loaded and run on a computer, causes the computer to perform corresponding flows performed by the mobile terminal/terminal device in various methods of the embodiments of the present disclosure, which is not repeated herein for brevity.

A computer program product is provided in the embodiments of the present disclosure. The computer program product includes a computer program instruction.

In some embodiments, the computer program product is applicable to the network device in the embodiments of the present disclosure, and the computer program instruction, when loaded and run on a computer, causes the computer to perform corresponding flows performed by the network device in various methods of the embodiments of the present disclosure, which is not repeated herein for brevity.

In some embodiments, the computer program product is applicable to the mobile terminal/terminal device in the embodiments of the present disclosure, and the computer program instruction, when loaded and run on a computer, causes the computer to perform corresponding flows performed by the mobile terminal/terminal device in various methods of the embodiments of the present disclosure, which is not repeated herein for brevity.

A computer program is provided in the embodiments of the present disclosure.

In some embodiments, the computer program is applicable to the network device in the embodiments of the present disclosure, and the computer program, when loaded and run on a computer, causes the computer to perform corresponding flows performed by the network device in various methods of the embodiments of the present disclosure, which is not repeated herein for brevity.

In some embodiments, the computer program is applicable to the mobile terminal/terminal device in the embodiments of the present disclosure, and the computer program, when loaded and run on a computer, causes the computer to perform corresponding flows performed by the mobile terminal/terminal device in various methods of the embodiments of the present disclosure, which is not repeated herein for brevity.

Those of ordinary skill in the art will appreciate that the units and algorithm steps of various examples described in connection with the embodiments disclosed herein may be implemented in electronic hardware, or a combination of computer software and electronic hardware. Whether these functions are performed in hardware or software depends on the particular application and design constraints of the technical solutions. Those skilled in the art may implement the described functions in varying ways for each particular application, but such implementations are not to be interpreted as departing from the scope of the present disclosure.

Those skilled in the art can clearly understand that, for convenience and brevity in description, the specific working processes of the systems, apparatuses, and units described above can refer to the corresponding processes in the aforementioned method embodiments, which are not repeated herein.

In the several embodiments provided in the present disclosure, it is understandable that the disclosed systems, apparatuses, and methods may be performed in other ways. For example, the above-described apparatus embodiments are merely illustrative. For example, the division of the units is only one type of logical functional division, and other divisions may be realized in practice. For example, a plurality of units or components may be combined or integrated into another system, or some features may be omitted, or not executed. In addition, the shown or discussed mutual coupling or direct coupling or communication connection may be an indirect coupling or communication connection through some interfaces, apparatuses, or units, and may be in an electrical, mechanical, or another form.

The units described as separate parts may or may not be physically separate, and parts displayed as units may or may not be physical units. The units may be located in one position, or may be distributed on a plurality of network units. Some or all of the units can be selected based on actual needs to achieve the purpose of the solutions of the embodiments.

In addition, various functional units in the embodiments of the present disclosure may be integrated into one processing unit, or various units may be physically present separately, or two or more units may be integrated into one unit.

The functions may be stored in a computer-readable storage medium if they are implemented in software functional units and sold or utilized as independent products. Based on such understandings, the technical solutions of the present disclosure substantially or a part thereof that contributes to the prior art, or a part of the technical solutions, may be embodied in a software product, which is stored in a storage medium and includes several instructions for causing a computer device (which may be a personal computer, a server, or a network device) to perform all or part of the processes of the methods as configured in the embodiments of the present disclosure. The aforementioned storage medium includes various medium capable of storing program codes, such as a U-disk, a mobile hard disk, a read-only memory (ROM), a random access memory (RAM), a magnetic disk, or an optical disk.

The above descriptions are only specific embodiments of the present disclosure, and the protection scope of the present disclosure is not limited to these. Any technical personnel skilled in the art can easily think of changes or substitutions within the technical scope disclosed herein, and these changes or substitutions should be covered within the protection scope of the present disclosure. Therefore, the protection scope of the present disclosure shall be subject to the protection scope of the claims.

1. A method for wireless communication, comprising:
determining, by a terminal device, a target modulation and coding scheme (MCS) for transmitting a physical uplink shared channel (PUSCH) based on a target MCS parameter and a target MCS information field, wherein the target MCS parameter indicates N MCS indexes, N being a positive integer greater than 1, and the PUSCH is configured to carry a message 3 (Msg3) in a random access process.

2. The method according to claim 1, wherein for initial transmission of the PUSCH, the target MCS information field is a first MCS information field carried in a random access response (RAR) uplink grant; or
for retransmission of the PUSCH, the target MCS information field is a second MCS information field carried in a downlink control information (DCI) format 0_0 scrambled by a temporary cell radio network temporary identifier (TC-RNTI).

3. The method according to claim 1, wherein the target MCS parameter comprises a second MCS parameter or a second default MCS parameter, the second MCS parameter being an MCS parameter for initial transmission and retransmission of the PUSCH, and the second default MCS parameter being a default MCS parameter for initial transmission and retransmission of the PUSCH.

4. The method according to claim 3, wherein the second MCS parameter indicates eight MCS indexes.

5. The method according to claim 3, wherein determining, by the terminal device, the target modulation and coding scheme (MCS) for transmitting the physical uplink shared channel (PUSCH) based on the target MCS parameter and the target MCS information field comprises:
determining a target MCS for initial transmission of the PUSCH based on two bits in a first MCS information field and first four MCS indexes in eight MCS indexes indicated by the second MCS parameter, wherein the two bits indicate a target MCS index in the first four MCS indexes.

6. The method according to claim 3, wherein determining, by the terminal device, the target modulation and coding scheme (MCS) for transmitting the physical uplink shared channel (PUSCH) based on the target MCS parameter and the target MCS information field comprises:
determining, in a case that the second MCS parameter is not configured, a target MCS for initial transmission of the PUSCH based on two bits in a first MCS information field and first four MCS indexes in eight MCS indexes indicated by the second default MCS parameter, wherein the two bits indicate a target MCS index in the first four MCS indexes.

7. The method according to claim 5, further comprising:
determining a target MCS for retransmission of the PUSCH based on three bits in a second MCS information field and eight MCS indexes indicated by the second MCS parameter, wherein the three bits indicate a target MCS index in the eight MCS indexes.

8. The method according to claim 5, further comprising:
determining, in a case that the second MCS parameter is not configured, a target MCS for retransmission of the PUSCH based on three bits in a second MCS information field and eight MCS indexes indicated by the second default MCS parameter, wherein the three bits indicate a target MCS index in the eight MCS indexes.

9. A terminal device, comprising: a processor and a memory, wherein the memory is configured to store a computer program, and the processor, when loading and running the computer program stored in the memory, is caused to perform:
determining a target modulation and coding scheme (MCS) for transmitting a physical uplink shared channel (PUSCH) based on a target MCS parameter and a target MCS information field, wherein the target MCS parameter indicates N MCS indexes, N being a positive integer greater than 1, and the PUSCH is configured to carry a message 3 (Msg3) in a random access process.

10. The terminal device according to claim 9, wherein for initial transmission of the PUSCH, the target MCS information field is a first MCS information field carried in a random access response (RAR) uplink grant; or
for retransmission of the PUSCH, the target MCS information field is a second MCS information field carried in a downlink control information (DCI) format 0_0 scrambled by a temporary cell radio network temporary identifier (TC-RNTI).

11. The terminal device according to claim 9, wherein the target MCS parameter comprises a second MCS parameter or a second default MCS parameter, the second MCS parameter being an MCS parameter for initial transmission and retransmission of the PUSCH, and the second default MCS parameter being a default MCS parameter for initial transmission and retransmission of the PUSCH.

12. The terminal device according to claim 11, wherein the second MCS parameter indicates eight MCS indexes.

13. The terminal device according to claim 11, wherein the processor, when loading and running the computer program stored in the memory, is caused to perform:
determining a target MCS for initial transmission of the PUSCH based on two bits in a first MCS information field and first four MCS indexes in eight MCS indexes indicated by the second MCS parameter, wherein the two bits indicate a target MCS index in the first four MCS indexes.

14. The terminal device according to claim 11, wherein the processor, when loading and running the computer program stored in the memory, is caused to perform:
determining, in a case that the second MCS parameter is not configured, a target MCS for initial transmission of the PUSCH based on two bits in a first MCS information field and first four MCS indexes in eight MCS indexes indicated by the second default MCS parameter, wherein the two bits indicate a target MCS index in the first four MCS indexes.

15. The terminal device according to claim 13, wherein the processor, when loading and running the computer program stored in the memory, is further caused to perform:
determining a target MCS for retransmission of the PUSCH based on three bits in a second MCS information field and eight MCS indexes indicated by the second MCS parameter, wherein the three bits indicate a target MCS index in the eight MCS indexes; or
determining, in a case that the second MCS parameter is not configured, a target MCS for retransmission of the PUSCH based on three bits in a second MCS information field and eight MCS indexes indicated by the second default MCS parameter, wherein the three bits indicate a target MCS index in the eight MCS indexes.

16. A network device, comprising:
a processor and a memory, wherein the memory is configured to store a computer program, which when executed by the processor, causes the processor to:
transmit a target modulation and coding scheme (MCS) parameter to a terminal device, wherein the target MCS parameter is configured to determine a target MCS for transmitting a physical downlink shared channel (PUSCH), the target MCS parameter indicates N MCS indexes, N being a positive integer greater than 1, and the PUSCH is configured to carry a message 3 (Msg3) in a random access process.

17. The network device according to claim 16, wherein the target MCS is determined based on the target MCS parameter and a target MCS information field; and
wherein for initial transmission of the PUSCH, the target MCS information field is a first MCS information field carried in a random access response (RAR) uplink grant, or for retransmission of the PUSCH, the target MCS information field is a second MCS information field carried in a downlink control information (DCI) format 0_0 scrambled by a temporary cell radio network temporary identifier (TC-RNTI).

18. The network device according to claim 16, wherein the target MCS parameter comprises a second MCS parameter, the second MCS parameter being an MCS parameter for initial transmission and retransmission of the PUSCH.

19. The network device according to claim 18, wherein the second MCS parameter indicates eight MCS indexes.

20. A chip, comprising:
a processor configured to execute a computer program from a memory, to cause a device installed with the chip to perform the method of claim 1.
